(19) United States
(12) Patent Application Publication
(10) Pub. No.: US 2004/0055998 A1
(43) Pub. Date: Mar. 25, 2004

(54) Method for providing a smooth wafer surface

(76) Inventors: Fabrice Letertre, Grenoble (FR); Claire Richtarch, Grenoble (FR)

Correspondence Address: WINSTON & STRAWN, PATENT DEPARTMENT, 1400 L STREET, N.W., WASHINGTON, DC, 20005-3502, US

(21) Appl. No.: 10/621,358

(22) Filed: Jul. 18, 2003

Related U.S. Application Data
(60) Provisional application No. 60/468,289, filed on May 5, 2003.

(30) Foreign Application Priority Data
Aug. 2, 2002 (FR) 0209869

(51) Int. Cl. B44C 1/22

(52) U.S. Cl. 216/52

(57) ABSTRACT

A method for providing a smooth wafer surface. The technique includes formulating an abrasive mixture by mixing diamond particles and silica particles in a solution based on a predetermined diamond/silica volume ratio mixing diamond particles, and polishing a surface of the wafer with the abrasive mixture to obtain a desired smoothness.

This application claims the benefit of co-pending U.S. Provisional Application No. 60/468,289 filed on May 5, 2003.

### BACKGROUND OF THE INVENTION

The present invention generally relates to a treatment for semiconductor materials for use in microelectronic and/or optoelectronic applications. More precisely, the invention relates to a method for providing a smooth wafer surface that includes formulating an abrasive mixture based on a predetermined diamond/silica volume ratio, and polishing a surface of the wafer with the abrasive mixture. The invention also relates to multilayer structures obtained by bonding together two or more wafers, at least one of the wafers being a wafer of material that has been polished by such a method. The invention may be applied to wafers of material purchased directly in the trade and having surface properties that are not compatible with molecular bonding, or may be used as a surface reconditioning treatment after removal and transfer of a thin layer.

The wafer materials of interest are preferably polar materials. Polar materials are defined as being materials made up of different types of atoms. Such polar materials present, when the material is in wafer form, one face in which a first atom is predominantly oriented, while the opposite face of the wafer has a second atom predominantly oriented. Generally, these atoms are oriented flush with the face.

The wafer materials may include semiconductor materials. For example, semiconductor polar materials include SiC, GaN, and AlN. The description given below of an implementation of the invention relates to a particular one of these materials: SiC, and this is described as an example of the others as well.

Methods are known that enable a silicon carbide surface to be obtained which presents, simultaneously, a good planar characteristic and a smooth surface (a roughness value that is as small as possible). The surface must be planar because such wafers of silicon carbide are typically used subsequently for bonding to another wafer by molecular bonding. It is important that the two surfaces which are brought together to achieve such molecular bonding to be planar, and typically these surfaces should not depart from a perfectly planar surface by any more than a value on the order of a few microns. A smooth surface is also necessary in order to be able to achieve molecular bonding. In semiconductor material applications of the type mentioned above, it is typically desirable to obtain a surface roughness not exceeding a value of about 0.5 nanometers (nm) in root mean square mean (rms) value.

A specific constraint associated with silicon carbide (SiC) is that the material presents extremely high mechanical hardness. In addition, the crystal structure of this material is anisotropic and oriented. Amongst other things, this means that the two opposite faces of an SiC wafer do not present the same crystal structure; one of the faces presents silicon atoms while the opposite face presents carbon atoms. These two characteristics make polishing SiC wafers extremely difficult, particularly when planar and smooth surface qualities such as those mentioned above are desired.

As mentioned above, methods are known which make use of at least one step of polishing the surface of an SiC wafer by means of a diamond abrasive (i.e. an abrasive based on diamond particles in suspension in a liquid). Such polishing generally makes it possible to obtain suitable planar surfaces. Nevertheless, the use of diamond particles may damage the polished SiC surface. Because of friction on the SiC surface, abrasive diamond particles generate crystal defects in a zone of the SiC wafer which becomes work-hardened due to the polishing. It is then necessary to proceed with successive polishing operations using diamond particles of decreasing diameter to successively eliminate the work-hardened zones that were generated by each preceding polishing step. An example of such a method is to be found in U.S. Pat. No. 5,895,583.

After successive mechanical polishing steps, it is also necessary to perform ionic surface etching in order to eliminate the few hundreds of nanometers (nm) of defective surface thickness material resulting from the previous polishing operation. At the end of such polishing operations, scratches can be observed in the surface of the SiC wafer. Such scratches must be eliminated by using an additional step of chemical and mechanical polishing (CMP).

It is difficult to implement CMP polishing with SiC material because the polished surfaces present low chemical reactivity with respect to this type of polishing (in particular when compared with the materials that are usually polished by CMP, such as silicon, GaAs, or InP). As a result, during the final operation of CMP polishing, the removal rate from the treated surface is low, being of the order of about 10 nm per hour. Consequently, it is very difficult to use CMP to erase surface defects left on the surface of an SiC wafer by successive diamond polishing operations. Thus, polishing SiC wafers in order to obtain suitable planar and smoothness characteristics that are compatible with subsequent molecular bonding presents substantial difficulties.

It is also known to polish a surface by implementing a mixture comprising abrasive particles mixed in a solution including a species that is chemically reactive with the surface to be polished. Such polishing, which is known as tribo-chemical polishing, combines the mechanical action of friction from abrasive particles with the chemical action of the reactive species, making it possible in particular to dissolve at least some of the defective surface atoms caused by the abrasive particles.

A description of an application of that type of polishing to treat a diamond surface can be found in the article “Diversity and feasibility of direct bonding: survey of a dedicated optical technology” by Haisma et al., Applied Optics, Vol. 33, No. 7, Mar. 1, 1994. That type of polishing thus makes it possible to obtain low values of surface roughness for a material that is very hard such as a diamond. In addition, such polishing does not generate the above-mentioned defects associated with methods of the type described in U.S. Pat. No. 5,895,583.

Returning to the context of the present invention, it would be desirable to have a tribo-chemical polishing technique that is designed for polishing the surfaces of SiC wafers. If one considers the teachings of Haisma et al., a suggestion of applying a mixture of (abrasive) diamond particles and a solution of (chemically active) silica might be tested to polish the surface of an SiC wafer. However, such an application has not yet been contemplated, and differences between the respective nature of a diamond and that of SiC present obstacles to such an application. Specifically, as mentioned above, SiC possesses an oriented crystal structure, and the teaching obtained concerning diamond is as a result not, a priori, applicable in any way to an SiC surface. Furthermore, even if such an application were contemplated, the conditions for implementing such polishing on an SiC wafer have not been defined by Haisma et al. or any other reference.

Thus, in general, it would be advantageous to be able to implement tribo-chemical polishing with an abrasive based on diamond particles in suspension in a solution, for use on wafers of materials of different types, so as to obtain a desired smooth wafer surface that subsequently could be bonded to other semiconductor substrates.

### SUMMARY OF THE INVENTION

The present invention relates to a method for providing a smooth wafer surface. The method includes formulating an abrasive mixture by mixing diamond particles and silica particles in a solution based on a predetermined diamond/silica volume ratio, and then polishing a surface of the wafer with the abrasive mixture to obtain a desired smooth wafer surface which is suitable for molecular bonding to another polished substrate surface.

The method enables successful bonding of the smooth wafer surface to at least one other wafer to form a multilayer structure. The method is specifically intended to be used on wafers of a polar material, and particularly semiconductor materials such as, e.g., silicon carbide. Advantageously, the diamond/silica volume ratio is in the range of from about 0.29 to 0.35, and preferably in the range of from about 0.3 to 0.33.

A preferred abrasive mixture includes colloidal silica of the Syton W30 type and diamond particles having a grain size of about 0.6 to 0.9 and preferably about 0.75 μm. The technique may include polishing with a polishing head rotating at between about 35 and 65 rpm and a polishing turntable also rotating at between about 35 and 65 rpm. Preferably, both the head and turntable rotate at around 50 rpm. The polishing head may be pressed against the wafer surface with a force of about 7 to 15 and preferably 10 daN. Polishing may be performed for a duration of between about 30 minutes and 2 hours, and preferably at about 1 hour. The method may also include polishing with at least one polishing cloth of the IC1000 type or the IC1400 type. Polishing may be performed on either the Si face and the C face of the SiC wafer with good results. The method may also include final cleaning to avoid crystallization of abrasive agents on the wafer surface.

The method according to the invention makes it possible to overcome the drawbacks and limitations mentioned above in reference to known techniques for polishing SiC surfaces, while obtaining the advantages of tribo-chemical polishing when applying the treatment to the surface of an SiC wafer.

### BRIEF DESCRIPTION OF THE DRAWING

Other features and advantages of the invention appear more clearly in the following description when reviewed in connection with the drawing figures, wherein:

FIG. 1 is a graph which shows how roughness varies after tribo-chemical polishing of the surface of a silicon carbide wafer as a function of the type of diamond/silica mixture used for polishing.

### DETAILED DESCRIPTION OF THE PREFERRED EMBODIMENTS

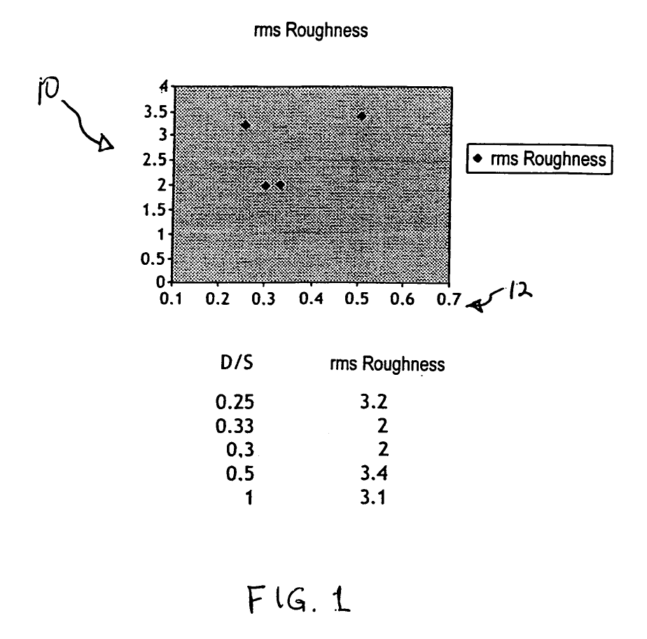

FIG. 1 shows how the roughness of the surface of an SiC wafer varies after tribo-chemical polishing using a mixture comprising abrasive diamond particles mixed in a silica solution. In this implementation, the diamond is a synthetic polycrystalline diamond, and the diamond particles may have a grain size of about 0.75 μm. The silica may be a colloidal silica of the Syton W30 type.

A rotary polishing turntable having a rotary polishing head was used to polish the wafer, with the head applied there against. The respective rotations of the turntable and of the head were performed about parallel axes. The most preferred rates of rotation may be about 50 revolutions per minute (rpm) for the turntable and for the head, with the turntable and head preferably having the same speed of rotation. More generally, the rate of rotation may lie in the range of 10 rpm to 100 rpm, with between 35 and 65 rpm being a more desirable value.

The turntable is generally covered in a polishing cloth, e.g., a cloth of the IC1000 or IC1400 type (available, for example, from the supplier Rodel). The wafer being polished was maintained between the turntable and the head, being driven by the rotation of the head which was pressed against the rear face of the wafer. (Thus, the face of the wafer that is exposed to the cloth is the face that is to be polished). The diamond and silica mixture was injected continuously between the polishing turntable covered in the abrasive cloth and the surface of the wafer to be polished. The head was pressed down with a force of about 10 daN, so as to press the SiC wafer being polished against the abrasive cloth. More broadly, the pressure may lie in the range 5 daN to 50 daN. Optionally, the polishing head could be mounted on an arm to enable a sweeping motion to be imparted to the head over the cloth during polishing.

The specific type of SiC wafer used was an SiC wafer of the type “4H-8° off”. In the example illustrated in FIG. 1, the surface polished was the silicon face, but polishing could equally well be applied to the carbon face.

The graph of FIG. 1 plots roughness (the ordinate axis) as obtained after polishing under the conditions specified below for a duration of about 1 hour. The roughness measure is expressed in rms angstrom (Å) values as measured by an optical profilometer. Values of the diamond/silica volume ratio, written “D/S ratio”, are plotted along the abscissa axis.

The graph of FIG. 1 include four reference points which correspond to the pairs of points (roughness, D/S ratio) given in the table below (the table also includes an additional pair that is not plotted on the graph):

| D/S | Roughness (Å rms) |
|---|---|
| 0.25 | 3.2 |
| 0.3 | 2 |
| 0.33 | 2 |
| 0.5 | 3.4 |
| 1 | 3.1 |

The initial roughness of the wafer as measured by an optical profilometer was 4 Å rms. From the points plotted in FIG. 1, it can be seen that each roughness measure was strongly influenced by the D/S ratio. The present method thus first identifies and characterizes the influence of the D/S ratio on the final roughness of the SiC wafer: A local roughness minimum exists over a range of values for the D/S ratio, with roughness increasing on either side for smaller and for greater values of the D/S ratio. More precisely, it can be seen that a smooth surface of particularly low roughness (about 2 Å rms) can be obtained when the D/S ratio lies in the range of 0.29 to 0.35, and more precisely still that the smoothest surface (of lowest roughness) is obtained when the D/S ratio lies in the range of 0.3 to 0.33. Consequently, implementing tribo-chemical polishing on an SiC surface can produce advantageous effects. Moreover, the smoothness of the surface obtained after polishing can be controlled by means of the D/S ratio.

It is desirable to select the ratio to be close to the above-mentioned values (i.e., the range of 0.29 to 0.35, and the more particularly preferred range of 0.3 to 0.33), in order to obtain a particularly small roughness values of about 2 Å rms. Consequently, the present method advantageously makes it possible to obtain very smooth surfaces for SiC wafers.

It should also be observed that the invention makes it possible to planarize SiC wafers without running the risk of damaging them. In this respect the invention differs from methods such as that described in U.S. Pat. No. 5,895,583. In fact, it has been found that the present method is effective in erasing the surface topology of the wafer, while greatly restricting the removal of material, which remains typically less than 2 μm. Thus, surfaces polished according to the present technique and observed with an optical profilometer are free from scratches.

The fact that the resulting surface is very smooth and has an extremely low roughness value provides excellent preparation for subsequent steps. For example, in order to perform ultrafinishing polishing by using pure colloidal silica, or by using a beam of ion aggregates, in order to achieve molecular bonding, or in order to perform epitaxial growth. It has also been observed that a cleaning step performed after polishing is particularly advantageous in order to avoid crystallization of abrasive agents on the surface. Such cleaning can be performed by rinsing the surface of the wafer with deionized water, and then cleaning said surface in a bath of hydrofluoric acid.

Planarizing such SiC surfaces is important, for example in the context of recycling the negatives that result from methods used to transfer layers, in which a thin layer is detached from a supporting substrate. In such methods, a portion of the support used for transferring a thin layer remains and can advantageously be recycled, providing its surface state is treated appropriately.

Although the particular example described with reference to FIG. 1 relates to a single crystal SiC wafer of the 4H polytype, and although it is the Si face that was polished, the present method is applicable to other types of SiC wafers (e.g. single crystal SiC of 6H or 3C polytype). Further, the method can also be applied to the C face of the wafer. The conditions under which the method is implemented (the type abrasive cloth selected, etc.) can be modified in this respect.

In general, the present method can be implemented on oriented materials (in particular on materials that are polar and semiconductive). It is also possible to implement the invention on materials that are not oriented.

In a variant, the polishing device can be integrated in a system for in-situ reviving, enabling the polishing cloth to be regenerated since it can become flattened during polishing, thereby enabling the cloth to retain all of its qualities.

What is claimed is:

1. A method for providing a smooth wafer surface comprising:
formulating an abrasive mixture by mixing diamond particles and silica particles in a solution based on a predetermined diamond/silica volume ratio; and
polishing a surface of the wafer with the abrasive mixture to obtain a desired smooth wafer surface that is sufficient for molecular bonding to another polished substrate face.

2. The method according to claim 1 further comprising bonding the smooth wafer surface to at least one other wafer to form a multilayer structure.

3. A method according to claim 1 wherein the wafer comprises a polar material.

4. A method according to claim 3 wherein the material is a semiconductor material.

5. A method according to claim 4 wherein the material is silicon carbide.

6. The method according to claim 4 wherein the predetermined volume ratio is 0.29 to 0.35.

7. The method according to claim 6 wherein the predetermined volume ratio is 0.3 to 0.33.

8. The method according to claim 4 wherein the silica is a colloidal silica and the diamond particles have a grain size of between about 0.6 and 0.9 μm.

9. A method according to claim 8 wherein the polishing is conducted with a polishing head rotating at between about 10 to 100 rpm and a polishing turntable also rotating at about 10 to 100 rpm.

10. A method according to claim 8 wherein the polishing is conducted with a polishing head rotating at between about 35 to 65 rpm and a polishing turntable also rotating at about 35 to 65 rpm.

11. A method according to claim 9 wherein the polishing head and turntable rotate at essentially the same speed.

12. A method according to claim 9 wherein the polishing head is pressed against the wafer surface with a force of about 10 to 50 daN.

13. A method according to claim 9 wherein the polishing head is pressed against the wafer surface with a force of about 7 to 15 daN.

14. A method according to claim 8 wherein the polishing is performed for a duration of about 30 minutes to 2 hours.

15. A method according to claim 8 which further comprises polishing with at least one of an IC1000 polishing cloth or an IC1400 polishing cloth.

16. A method according to claim 5 wherein polishing is performed on at least one of the Si face of the wafer or the C face of the wafer.

17. A method according to claim 1 further comprising final cleaning to avoid crystallization of abrasive agents on the wafer surface.
